(19) United States
(12) Patent Application Publication
(10) Pub. No.: US 2009/0267956 A1
(43) Pub. Date: Oct. 29, 2009

(54) SYSTEMS, METHODS AND ARTICLES FOR VIDEO CAPTURE

(75) Inventors: Allen W. Greaves, Spokane, WA (US); Charles F. Manning, Sandpoint, ID (US)

Correspondence Address: CALFEE HALTER & GRISWOLD, LLP, 800 SUPERIOR AVENUE, SUITE 1400, CLEVELAND, OH, 44114, US

(73) Assignee: PLAYXPERT, LLC, Sandpoint, ID (US)

(21) Appl. No.: 12/431,110

(22) Filed: Apr. 28, 2009

Related U.S. Application Data
(60) Provisional application No. 61/048,264, filed on Apr. 28, 2008.

(51) Int. Cl. G06T 9/00

(52) U.S. Cl. 345/555

(57) ABSTRACT

Video capture of the output of a computer game is achieved by recording, analyzing and compressing source data output by the computer game, wherein the source data is pre-rasterized graphics data generated by a graphics library. Thus, video capture and subsequent playback of the captured video data involves use of the source data as opposed to raw data resulting from the rasterization of the source data by graphics hardware.

### RELATED APPLICATION

The present application is being filed as a non-provisional patent application claiming priority/benefit under 35 U.S.C. §119(e) from U.S. Provisional Patent Application No. 61/048,264 filed on Apr. 28, 2008, which is incorporated herein by reference in its entirety.

### FIELD

The invention relates generally to software modules and, more particularly, to systems, methods and articles for capturing, storing and/or manipulating graphics data.

### BACKGROUND

Computer games include software that is installed on a computer. An operating system (OS) of the computer can then execute (i.e., “run”) the game. In general, the operating system running the computer game causes a graphics card/processor of the computer to display images and video on a display (e.g., an LCD monitor) of the computer. The operating system running the computer game can also cause an audio card/processor of the computer to output sounds and/or music through speakers of the computer. An input device (e.g., a keyboard and/or a mouse) of the computer can be used to allow a user to interact with the computer game.

The computer games, or third party programs for interfacing with the computer games, can allow a user to capture the images and video generated by the computer game using a process called video capture. Conventional video capture for computer games is implemented in products such as Fraps (see, e.g., http://www.fraps.com/) and WeGame (see, e.g., http://www.wegame.com/). Fraps is an application that can perform, among other things, real-time recording of audio and video for computer games using OpenGL graphics technology or Microsoft's DirectX graphics technology, as well as taking screen shots (i.e., capturing still images) from the computer games in response to user input (e.g., pressing a keyboard key). WeGame provides an application that works with Microsoft's DirectX graphics technology to capture a series of screen shots as video data from a video game in response to user input (e.g., pressing a keyboard key), wherein the video data is output to an Audio Video Interleave (AVI) file. The AVI file can then be uploaded to the WeGame website where it can be viewed by others via the Internet.

As shown in FIG. 1, the conventional approach to performing video capture in a computer game 102, such as used by the Fraps and WeGame applications, involves accessing raw post-rasterized data 104 from a front buffer 106 of display hardware 108 (e.g., a graphics card) of a computer 100 running the computer game 102. The computer game 102 uses a graphics library 110 (e.g., OpenGL, DirectX) and a graphics driver 112 to output graphics data. The graphics data goes through a rasterization process within the display hardware 108. In particular, a graphics processing unit (GPU) 114 in the display hardware 108 rasterizes the graphics data from the graphics driver 112, as known in the art. The display hardware 108 also has two buffers: a back buffer 116 and the front buffer 106. Once the graphics data in the back buffer 116 is fully rasterized, the graphics data is switched to the front buffer 106 as the raw data 104 for display. The front buffer 106 stores the raw data 104 constituting presentable information that is ready to be displayed on a display device (not shown) of the computer 100. The GPU 114 working in combination with the front and back buffers 106, 116 produces, on a frame by frame basis, the video output of the computer game 102 during play. A video capture application 118 (e.g., Fraps, WeGame) can access the raw data 104 from the front buffer 106 of the display hardware 108 of the computer 100. After retrieving the raw data 104 from the front buffer 106, the video capture application 118 compresses 120 the raw data 104 into compressed data and then saves 122 the compressed data to a data store (not shown). This conventional approach to performing video capture suffers from numerous drawbacks.

For example, the conventional approach to performing video capture gives rise to space/size issues. Because the raw data 104 stored in the front buffer 106 of the display hardware 108 is uncompressed, a relatively large amount of physical storage space is required to store even a single frame of the video data. Accordingly, some compression is necessary to reduce the size of the raw data to a more manageable size for the purpose of video capture. Even with compression, video capture sizes can be quite large. Consider, for example, that using the Fraps application to record a 60 second movie with a 30 frames per second (fps) recording profile could produce a movie file (as the video data) having a size exceeding 940 MB. The required write rate for this movie file would be approximately 15.7 MB/second.

Compression 120 of the raw data 104 also involves tradeoffs between gameplay performance (i.e., performance of the computer 100) and quality of the stored video data, with respect to the amount of space required to store the video data. The compression 120 of the raw data 104 gives rise to performance penalties, as compression is generally a CPU-intensive process. Additionally, the process of saving 122 the compressed data to the data store can also occupy the CPU of the computer 100 to the detriment of the computer game 102 running thereon. The compression 120 of the raw data 104 also gives rise to quality issues relating to the stored video data. Higher-quality video data is more CPU-intensive to playback and requires more space to store. Since each frame of the raw data 104 requires a significant amount of storage space, skipping frames of the raw data 104 during the video capture sacrifices playback quality but reduces the impact on the performance of the computer 100 and the space needed to store the captured video data. Resolution refers to the amount of the raw data 104 being retrieved or otherwise used. Lower resolutions sacrifice playback quality but reduce the impact on the performance of the computer 100 and the space needed to store the captured video data.

Another drawback of the conventional approach to performing video capture is that it results in a static domain. Each frame of the raw data 104 is a single picture. Unlike the three dimensional environment presented during the gameplay of the computer game 102, the graphics data is two dimensional in nature once it is rasterized (by the rasterization process) into a series of static images. As a result, further processing on top of the static images is limited to overlaying text or graphics, as well as adding effects (e.g., transitions) to the movies made from the images. Thus, manipulation of the captured video data is limited.

Consequently, there is a need in the art for systems, methods and articles that allow users to record, analyze and playback captured video data in its source format, as opposed to post-rasterized images collated into a frame-by-frame movie.

### SUMMARY

In view of the above, it is an exemplary aspect to provide a system, a method and an article for performing video capture of graphics data output from a computer game.

It is another exemplary aspect to provide a system for performing video capture of graphics data in its source format, as opposed to post-rasterized images collated into a frame-by-frame movie.

It is yet another exemplary aspect to provide a method of performing video capture of graphics data in its source format, as opposed to post-rasterized images collated into a frame-by-frame movie.

It is still another exemplary aspect to provide an article of manufacture comprising a computer-readable medium tangibly embodying instructions readable by a computer for performing a method of performing video capture of graphics data in its source format, as opposed to post-rasterized images collated into a frame-by-frame movie.

### BRIEF DESCRIPTION OF THE DRAWINGS

The above aspects and additional aspects, features and advantages will become readily apparent by describing in detail exemplary embodiments thereof with reference to the attached drawings, wherein like reference numerals denote like elements, and:

FIG. 1 is a diagram of a conventional system for performing video capture of gameplay from a computer game.

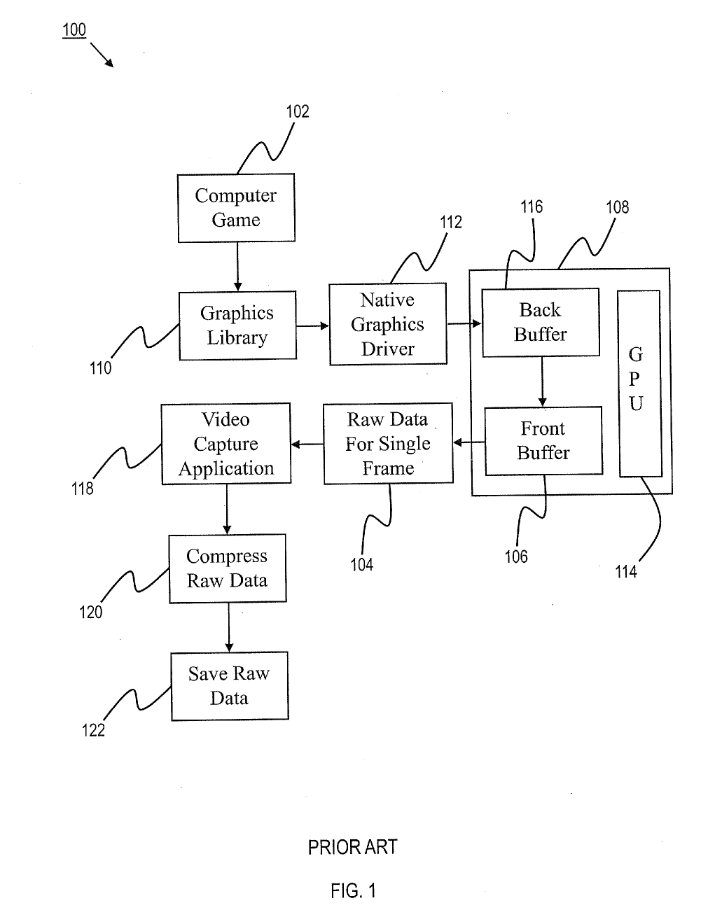

FIG. 2 is a diagram of a system for performing video capture of gameplay from a computer game, according to one exemplary embodiment.

FIG. 3 is a diagram of a system for performing video capture of gameplay from a computer game, according to one exemplary embodiment.

FIG. 4 is a flowchart of a method of performing video capture of gameplay from a computer game, according to one exemplary embodiment.

### DETAILED DESCRIPTION

While the general inventive concepts are susceptible of embodiment in many different forms, there are shown in the drawings and will be described herein in detail specific embodiments thereof with the understanding that the present disclosure is to be considered as an exemplification of the principles of the general inventive concepts. Accordingly, the general inventive concepts are not intended to be limited to the specific embodiments illustrated herein.

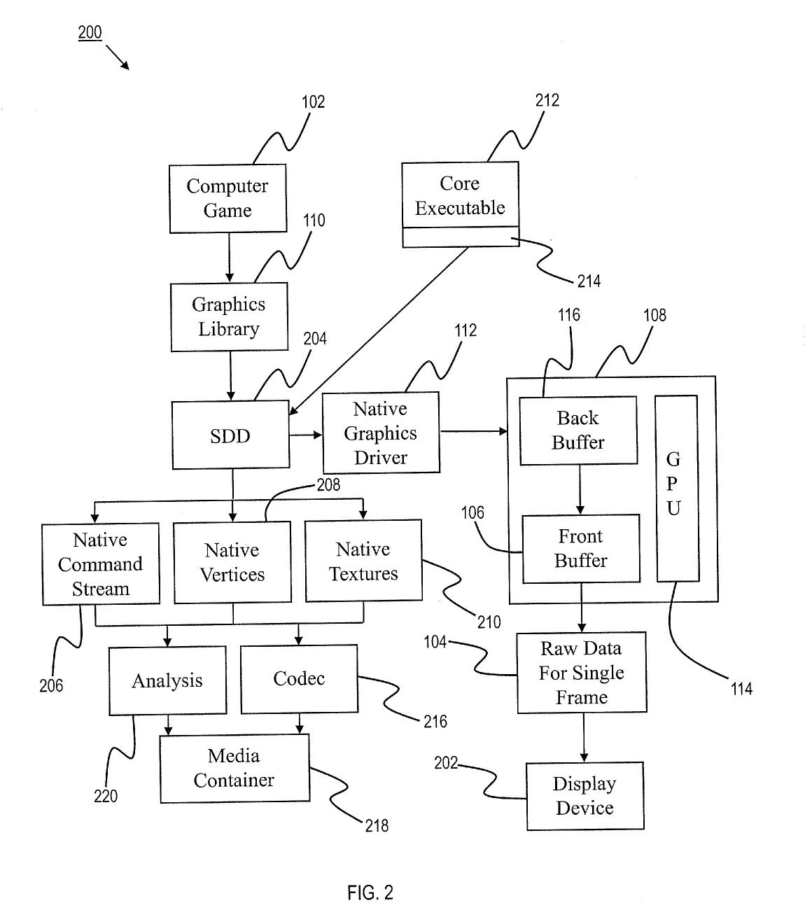

A system for capturing graphics data output by an application running on a computer, according to one exemplary embodiment, will now be described with reference to FIG. 2. For example, the system can be used to perform video capture during gameplay of a computer game. In FIG. 2, a computer 200 includes an operating system (e.g., Microsoft's Windows XP or 2000 operating system) which is operable to execute a computer game 102. The operating system includes a user layer and a kernel layer, as known in the art. User applications (e.g., the computer game 102) typically occupy the user layer, while the kernel layer functions to manage the hardware components (e.g., a CPU, memory, input/output (I/O) devices) of the computer 200 and allow the user applications to run and use these hardware components. Thus, the kernel layer manages communication between the software applications in the user layer and the hardware components of the computer 200.

The computer game 102 running on the computer 200 makes calls to a graphics library 110 (e.g., OpenGL, DirectX) to generate graphics data in a source format (i.e., in a format defined by the graphics library 110). The graphics data in the source format (hereinafter, the source data) has not yet been subjected to rasterization (e.g., by a rasterization process). The source data is then sent to a display/graphics driver 112 to output the graphics data. The graphics driver 112 is a software program (residing in the user layer of the operating system) that controls a display device 202 (e.g., an LCD monitor) that is attached to display hardware 108 (e.g., a graphics card) of the computer 200. The graphics driver 112 converts the general I/O instructions of the operating system to instructions that the display device 202 can understand. Depending on these instructions, certain data such as vertex, lighting, and texture information gets sent to the display hardware 108 to be processed by a graphics processing unit (GPU) 114 thereof.

In particular, the GPU 114 rasterizes the graphics data from the graphics driver 112 and sends it to the display buffer chain, as known in the art. This rasterized information is rotated through the display buffer chain to the front buffer. One of ordinary skill in the art will appreciate that the display buffer chain can include any number of physical and/or logical buffers. For example, the display hardware 108 has two buffers: a back buffer 116 and a front buffer 106. The back buffer 116 stores the unprocessed graphics data, wherein once the graphics data is fully rasterized, the processed graphics data is switched to the front buffer 106 as raw data 104 for display. The front buffer 106 stores the raw data 104 constituting presentable information that is ready to be displayed on the display device 202 of the computer 200. The GPU 114 working in combination with the front and back buffers 106, 116 produces, on a frame by frame basis, the video output of the computer game 102 during gameplay. This video output is displayed on the display device 202 of the computer 200 and is constantly updated to reflect changes during gameplay.

In performing video capture of the output of the computer game 102, the raw data 104 stored in the front buffer 106 of the display hardware 108 is not used. Instead, the computer 200 includes a supplanting display driver (SDD) 204 located in the kernel layer of the operating system. As described below, it is also contemplated that the SDD 204 could be located in the user layer of the operating system. The SDD 204 supplants the native graphics driver 112, such that the graphics driver 112 is subordinate to the SDD 204. In one exemplary embodiment, a special section name (e.g., “.SDDN”) is added in the image of the SDD 204 at compile time, wherein a dynamic linker can look for the special section name. Typically, driver images have a specific format, wherein all code and data in the image is stored in a number of sections. For example, a Portable Executable (PE) file format, as set out in the Microsoft Portable Executable and Common Object File Format Specification, implements such a file format. Each of the sections has a name, an address, a length and page protection characteristics that describe whether the section can be read, written and/or executed once loaded by a loader service.

At runtime, the SDD 204 monitors various functions (see, e.g., the Windows Driver Kit (WDK) and corresponding documentation). The WDK details all of the functions that a graphics driver written for the Windows 2000/XP display driver model is expected to implement. The functions monitored by the SDD 204 can include: PDEV creation (wherein a PDEV is a logical representation of the physical device); PDEV enabling/disabling; driver load/unload; DirectDraw enable/disable requests (wherein DirectDraw is part of Microsoft's DirectX application programming interface (API) and is used to render graphics in applications); Direct3D context creation/destruction (wherein Direct3D is part of the DirectX API and is used to render three dimensional graphics in applications); DirectX exclusive mode notifications (wherein DirectX is a collection of APIs for handling tasks related to multimedia, especially game programming and video, in the Microsoft operating system); surface creation within Direct3D; and all Direct3D drawing operations.

In order to monitor and/or modify (e.g., inject additional tokens into) the DirectX command stream, the SDD 204 implements a command stream monitor that interprets each token in accordance with the DirectX specification (see, e.g., the DirectX SDK) before the tokens are sent to the graphics driver 112. The command stream includes handles to vertex buffers, index buffers, n-dimensional textures, and tokens that alter the state of the graphics driver 112.

Because the graphics driver 112 is subordinate to the SDD 204, the SDD 204 can route the source data, including a native command stream 206, native vertices 208 and native textures 210 from the graphics library 110, elsewhere, in addition to the native graphics driver 112 (see FIG. 2). In this manner, the SDD 204 can effectively create copies of the source data as needed.

The native command stream 206 refers to the command stream of the graphics library 110 (e.g., the DirectX command stream). The source data, as pre-rasterized data, is in vector graphics form. In vector graphics, geometrical primitives such as points, lines and polygons, which are all based upon mathematical equations, are used to represent images in the graphics data output by the computer game 102. All other graphic elements are built up from these primitives. Furthermore, the polygons are represented as collections of triangles, with each triangle being represented by 3 vertices in 3-space. The native vertices 208 refer to the vertices of the triangles representing the various polygons forming the 3-dimensional scene as the output of the computer game 102. Likewise, the native textures 210 refer to texture maps (e.g., bitmaps) that are applied to (i.e., mathematically mapped on) the triangles representing the various polygons in the 3-dimensional scene. A texture map defines the look of the triangle to which it is applied. Application of the texture map onto the triangle provides detail beyond simple coloring and shading.

In one exemplary embodiment, the SDD 204 resides in the kernel layer of the operating system of the computer 200, while a core executable 212 as the video capture application resides in the user layer of the operating system. The core executable 212 includes a user interface 214 for the SDD 204 (see FIG. 2). The user interface 214 enables the core executable 212 to interact with the SDD 204. Because the source data is in the kernel layer and processes in the user layer such as the core executable 212 are generally not permitted to allocate memory at the kernel layer, the SDD 204 allocates memory at the kernel layer and copies the source data into the allocated memory for access by the core executable 212. In this manner, the source data from the graphics library 110 can be passed from the SDD 204 in the kernel layer to the core executable 212 in the user layer via the user interface 214. Operation of the SDD 204, as well as the core executable 212 and its user interface 214 for the SDD 204, are transparent to the computer game 102. Because the SDD 204 works in conjunction with the native graphics driver 112, the source data (including the native command stream 206, the native vertices 208 and the native textures 210) can be captured in real time without impacting the flow of the source data to its intended destination (e.g., the display hardware 108 for display on the display device 202).

The core executable 212 and the SDD 204 work with a codec 216 to perform the video capture. The codec 216 is a program or module that can encode and/or decode a data stream (e.g., the source data). The codec 216 is used to process the source data for placement in a media container 218 such as an Audio Video Interleave (AVI) file, as described below.

For performing the video capture of the output of the computer game 102, a mechanism is needed for transporting the source data to be modified and stored. In one exemplary embodiment, the mechanism is Microsoft's DirectShow, (see, e.g., the DirectShow specification). DirectShow is a multimedia framework and API for performing various operations with media files or streams. DirectShow provides a common interface for media across different programming languages and is an extensible, filter-based framework that can render or record media files.

In order to receive data from the SDD 204, a DirectShow source filter is used to connect with the data stream and send it to be modified and stored. The source data is made up of command data (e.g., the native command stream 206), vertex data (e.g., the native vertices 208), and texture data (e.g., the native textures 210). The vertex and texture data are relatively static. This data will flow through in packets. Using the DirectShow source filter to capture the source data provides flexibility because another DirectShow filter can be placed between the source filter and the media container 218 in which the captured source data is stored. Accordingly, the source data can be transformed or otherwise modified by this intermediate DirectShow filter before it reaches the media container 218 for storage therein. In one exemplary embodiment, a DirectShow destination filter is used to convert the source data into a container format (i.e., corresponding to the media container 218) and write it to a storage medium (e.g., disk).

A DirectShow transform filter (e.g., the intermediate DirectShow filter) performs analysis 220 on the source data and sends it through the codec 216. The codec 216 compresses the source data using knowledge of the native command stream 206. Even before compression by the codec 216, the captured source data is relatively small as compared to the post-rasterization raw data 104. Using the analysis 220 on the native command stream 206, such as a DirectX command stream, the codec 216 is able to further decrease the size of the source data relative to the raw data 104. Because the native command stream 206 is structured, the codec 216 can compress the source data based on the analysis 220 of command tokens in the native command stream 206. For example, a statistical model of these command tokens is built and based on a likelihood of each command token appearing, the codec 216 is able to efficiently compress the source data.

Once compressed by the codec 216, the compressed source data is converted to the format of the media container 218 for storage. Once the captured video data is stored, it can later be accessed for playback. Playback of the video data involves decoding of the video data, which is done by reversing the process of compressing the source data via the codec 216. This compression step can be a two pass approach; the initial capture will shrink redundancies while the second pass will do a full entropic encoding. This can be changed by the user and illustrates the unique and flexible nature of compression within the general inventive concepts. As the video data is being decompressed for playback, a user can insert commands made up of DirectX method calls into the native command stream 206 to modify the video data (e.g., change the point of view) or achieve other effects during playback. In one exemplary embodiment, the user can readily jump to a particular location anywhere in the captured video data during playback.

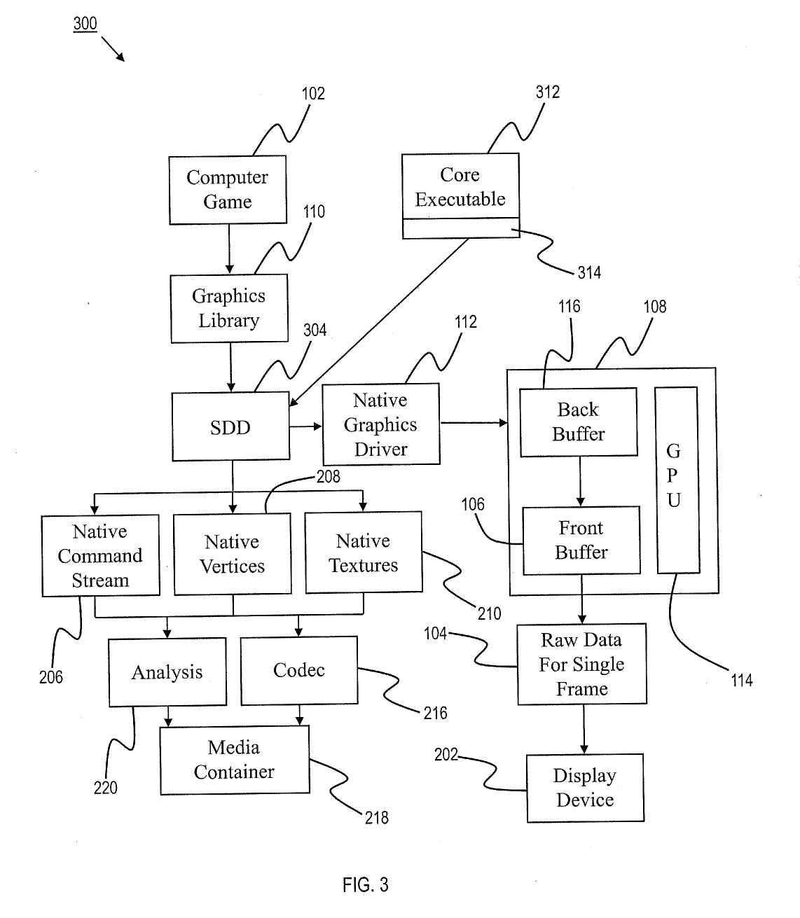

A system for capturing graphics data output by an application running on a computer, according to one exemplary embodiment, will now be described with reference to FIG. 3. For example, the system can be used to perform video capture during gameplay of a computer game. In FIG. 3, a computer 200 includes an operating system (e.g., Microsoft's Vista operating system) which is operable to execute a computer game 102. The operating system includes a user layer and a kernel layer, as known in the art. User applications (e.g., the computer game 102) typically occupy the user layer, while the kernel layer functions to manage the hardware components (e.g., a CPU, memory, input/output (I/O) devices) of the computer 200 and allow the user applications to run and use these hardware components. Thus, the kernel layer manages communication between the software applications in the user layer and the hardware components of the computer 200.

The computer game 102 running on the computer 200 makes calls to a graphics library 110 (e.g., OpenGL, DirectX) to generate graphics data in a source format (i.e., in a format defined by the graphics library 110). The graphics data in the source format (hereinafter, the source data) has not yet been subjected to rasterization (e.g., by a rasterization process). The source data is then sent to a display/graphics driver 112 to output the graphics data. The graphics driver 112 is a software program (residing in the user layer of the operating system) that controls a display device 202 (e.g., an LCD monitor) that is attached to display hardware 108 (e.g., a graphics card) of the computer 200. The graphics driver 112 converts the general I/O instructions of the operating system to instructions that the display device 202 can understand. Depending on these instructions, certain data such as vertex, lighting, and texture information gets sent to the display hardware 108 to be processed by a graphics processing unit (GPU) 114 thereof.

In particular, the GPU 114 rasterizes the graphics data from the graphics driver 112 and sends it to the display buffer chain, as known in the art. This rasterized information is rotated through the display buffer chain to the front buffer. One of ordinary skill in the art will appreciate that the display buffer chain can include any number of physical and/or logical buffers. For example, the display hardware 108 has two buffers: a back buffer 116 and a front buffer 106. The back buffer 116 stores the unprocessed graphics data, wherein once the graphics data is fully rasterized, the processed graphics data is switched to the front buffer 106 as raw data 104 for display. The front buffer 106 stores the raw data 104 constituting presentable information that is ready to be displayed on the display device 202 of the computer 200. The GPU 114 working in combination with the front and back buffers 106, 116 produces, on a frame by frame basis, the video output of the computer game 102 during gameplay. This video output is displayed on the display device 202 of the computer 200 and is constantly updated to reflect changes during gameplay.

In performing video capture of the output of the computer game 102, the raw data 104 stored in the front buffer 106 of the display hardware 108 is not used. Instead, the computer 200 includes a supplanting display driver (SDD) 304 located in the user layer of the operating system. The SDD 304 is located between the graphics library 110 (e.g., the Direct3D runtime library) and the graphic driver 112, in the user layer of the operating system.

The SDD 304 supplants the native graphics driver 112, such that the graphics driver 112 is subordinate to the SDD 304. In one exemplary embodiment, a special section name (e.g., “.SDDN”) is added in the image of the SDD 304 at compile time, wherein a dynamic linker can look for the special section name. Typically, driver images have a specific format, wherein all code and data in the image is stored in a number of sections. For example, a Portable Executable (PE) file format, as set out in the Microsoft Portable Executable and Common Object File Format Specification, implements such a file format. Each of the sections has a name, an address, a length and page protection characteristics that describe whether the section can be read, written and/or executed once loaded by a loader service.

In performing video capture of the output of the computer game 102 running under the operating system (e.g., the Vista operating system), the raw data 104 stored in the front buffer 106 of the display hardware 108 is not used. Instead, a core executable 312 uses the SDD 304 to perform the video capture. The core executable 312 embodies the video capture application. Like the SDD 304, the core executable 312 resides in the user layer of the operating system. The core executable 312 includes a user interface 314 for the SDD 304 (see FIG. 3). The user interface 314 enables the core executable 312 to interact with the SDD 304. Operation of the SDD 304, as well as the core executable 312 and its user interface 314 for the SDD 304, are transparent to the computer game 102. Because the SDD 304 works in conjunction with the native graphics driver 112, the source data (including the native command stream 206, the native vertices 208 and the native textures 210) can be captured in real time without impacting the flow of the source data to its intended destination (e.g., the display hardware 108 for display on the display device 202).

In one exemplary embodiment, the core executable 312 initiates a remote process corresponding to the computer game 102 and then stops its execution. In this manner, the core executable 312 is able to load the graphics driver 112 into the process, followed by the SDD 304 with a pointer to the location of the graphics driver 112 running in the process of the computer game 102. A remote thread is allowed execution into the remote process where the exported functions of the graphics driver 112 are changed to point to function addresses specific to the SDD 304. The SDD 304 then takes care of transporting information back and forth from the graphics library 110 (e.g., Direct3D runtime) and the graphics driver 112.

At runtime, the SDD 304 monitors various functions (see, e.g., the Windows Driver Kit (WDK) and corresponding documentation). The WDK details all of the functions that a graphics driver written for the Windows Vista display driver model is expected to implement. The functions monitored by the SDD 304 can include: Direct3D context creation/destruction (wherein Direct3D is part of the DirectX API and is used to render three dimensional graphics in applications); DirectX exclusive mode notifications (wherein DirectX is a collection of APIs for handling tasks related to multimedia, especially game programming and video, in the Microsoft operating system); surface creation within Direct3D; and all Direct3D drawing operations.

In order to monitor and/or modify (e.g., inject additional tokens into) the DirectX command stream, the SDD 304 implements a command stream monitor that interprets each token in accordance with the DirectX specification (see, e.g., the DirectX SDK) before the tokens are sent to the graphics driver 112. The command stream includes handles to vertex buffers, index buffers, n-dimensional textures, and tokens that alter the state of the graphics driver 112.

Because the graphics driver 112 is subordinate to the SDD 304, the SDD 304 can route the source data, including a native command stream 206, native vertices 208 and native textures 210 from the graphics library 110, elsewhere, in addition to the native graphics driver 112 (see FIG. 3). In this manner, the SDD 304 can effectively create copies of the source data as needed.

The native command stream 206 refers to the command stream of the graphics library 110 (e.g., the DirectX command stream). The source data, as pre-rasterized data, is in vector graphics form. In vector graphics, geometrical primitives such as points, lines and polygons, which are all based upon mathematical equations, are used to represent images in the graphics data output by the computer game 102. All other graphic elements are built up from these primitives. Furthermore, the polygons are represented as collections of triangles, with each triangle being represented by 3 vertices in 3-space. The native vertices 208 refer to the vertices of the triangles representing the various polygons forming the 3-dimensional scene as the output of the computer game 102. Likewise, the native textures 210 refer to texture maps (e.g., bitmaps) that are applied to (i.e., mathematically mapped on) the triangles representing the various polygons in the 3-dimensional scene. A texture map defines the look of the triangle to which it is applied. Application of the texture map onto the triangle provides detail beyond simple coloring and shading.

As noted above, in this exemplary embodiment, the SDD 304 resides in the user layer of the operating along with the core executable 212 (i.e., the video capture application). Transportation of the captured data (e.g., video data) will be similar to the SDD 204, but since the SDD 304 is in the user layer, capturing the data to a medium will not require exporting it out of the kernel layer. Instead a direct map to the hard disk will suffice. Compression can be done on the data asynchronously of the computer game 102, such that frame rates are not impacted.

The core executable 212 and the SDD 304 work with a codec 216 to perform the video capture. The codec 216 is a program or module that can encode and/or decode a data stream (e.g., the source data). The codec 216 is used to process the source data for placement in a media container 218 such as an Audio Video Interleave (AVI) file, as described herein.

For performing the video capture of the output of the computer game 102, a mechanism is needed for transporting the source data to be modified and stored. In one exemplary embodiment, the mechanism is Microsoft's DirectShow, (see, e.g., the DirectShow specification). DirectShow is a multimedia framework and API for performing various operations with media files or streams. DirectShow provides a common interface for media across different programming languages and is an extensible, filter-based framework that can render or record media files.

In order to receive data from the SDD 304, a DirectShow source filter is used to connect with the data stream and send it to be modified and stored. The source data is made up of command data (e.g., the native command stream 206), vertex data (e.g., the native vertices 208), and texture data (e.g., the native textures 210). The vertex and texture data are relatively static. This data will flow through in packets. Using the DirectShow source filter to capture the source data provides flexibility because another DirectShow filter can be placed between the source filter and the media container 218 in which the captured source data is stored. Accordingly, the source data can be transformed or otherwise modified by this intermediate DirectShow filter before it reaches the media container 218 for storage therein. In one exemplary embodiment, a DirectShow destination filter is used to convert the source data into a container format (i.e., corresponding to the media container 218) and write it to a storage medium (e.g., disk).

A DirectShow transform filter (e.g., the intermediate DirectShow filter) performs analysis 220 on the source data and sends it through the codec 216. The codec 216 compresses the source data using knowledge of the native command stream 206. Even before compression by the codec 216, the captured source data is relatively small as compared to the post-rasterization raw data 104. Using the analysis 220 on the native command stream 206, such as a DirectX command stream, the codec 216 is able to further decrease the size of the source data relative to the raw data 104. Because the native command stream 206 is structured, the codec 216 can compress the source data based on the analysis 220 of command tokens in the native command stream 206. For example, a statistical model of these command tokens is built and based on a likelihood of each command token appearing, the codec 216 is able to efficiently compress the source data.

Once compressed by the codec 216, the compressed source data is converted to the format of the media container 218 for storage. Once the captured video data is stored, it can later be accessed for playback. Playback of the video data involves decoding of the video data, which is done by reversing the process of compressing the source data via the codec 216. This compression step can be a two pass approach; the initial capture will shrink redundancies while the second pass will do a full entropic encoding. This can be changed by the user and illustrates the unique and flexible nature of compression within the general inventive concepts. As the video data is being decompressed for playback, a user can insert commands made up of DirectX method calls into the native command stream 206 to modify the video data (e.g., change the point of view) or achieve other effects during playback. In one exemplary embodiment, the user can readily jump to a particular location anywhere in the captured video data during playback.

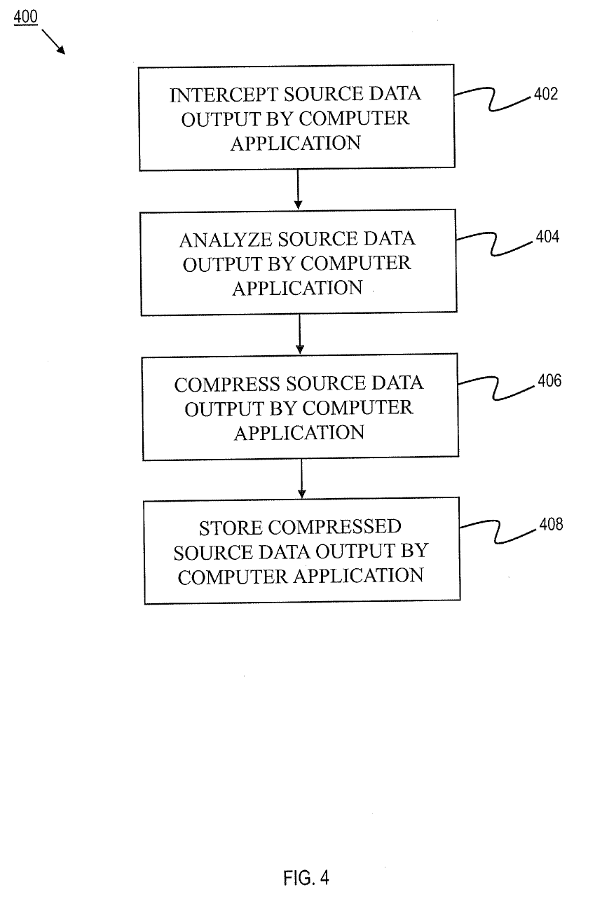

A method of capturing graphics data output by an application running on a computer, according to one exemplary embodiment, will now be described with reference to FIG. 4. For example, the method can be used to perform video capture during gameplay of a computer game. According to the method 400, source data output by a computer application (e.g., a computer game) and generated using a graphics library is intercepted in step 402. Here, interception of the source data refers to routing the source data to a destination instead of or in addition to its intended destination. Typically, the intended destination of the source data is a native graphics driver that processes (e.g., rasterizes) the source data for presentation on a display device (e.g., an LCD monitor). In one exemplary embodiment, a supplanting display driver (SDD) residing in a user layer or kernel layer of an operating system, intercepts the source data. In one exemplary embodiment, the source data includes a native command stream, native vertices and native textures.

The intercepted source data is analyzed in step 404. Analysis of the source data includes analyzing the command tokens in the native command stream. This analysis of the native command stream provides information that can be used to compress the source data in step 306. In one exemplary embodiment, a statistical model derived from the analysis of the native command stream in step 404 is used to compress the source data in step 406 (e.g., using a codec). Once the source data is compressed, it is stored (e.g., written to a disk medium) in step 408. Thereafter, the captured video data written to the disk can be retrieved and decompressed for purpose of playback. In one exemplary embodiment, the compressed source data is converted to the format of a media container (e.g., the AVI format) prior to being written to the disk as an AVI file. This conversion allows DirectShow to pick the correct codec for decompression and playback so standard off-the-shelf players that support autoplay, like Microsoft's Windows Media Player, will be able to play the video, without requiring a proprietary or specialized technology for playback. Furthermore, this approach allows third party applications to be interfaced with the codec so that users can leverage third party tools to modify the video and utilize the benefits of the pre-rasterized data in its source form.

In view of the above, the systems for performing video capture shown in FIGS. 2 and 3, as well as the method of performing video capture shown in FIG. 4, can record, analyze and replay graphics runtime data from a computer application, such as the computer game 102. More specifically, the systems/method can record, analyze and replay the graphics output by the computer game 102 using the source data (e.g., the native command stream 206, the native vertices 208 and the native textures 210), as opposed to the resulting “image” information (e.g., the raw data 104) that is rasterized by the display hardware 108 of the computer 200. Because the systems/method performs video capture using the pre-rasterized source data, the system/method may provide advantages over conventional video capture techniques.

For example, because the source data (e.g., the native command stream 206, the native vertices 208 and the native textures 210) is considerably smaller than the raw data 104 (i.e., frame-by-frame rasterized images) at the outset, compression of the source data does not tax the performance of the computer 200 nearly as much as compression of the raw data 104. Furthermore, compression of the source data results in a considerable space savings relative to the raw data 104. For example, as noted above, using the conventional Fraps application to record a 60 second movie with a 30 frames per second (fps) recording profile could produce a movie file (as the video data) having a size exceeding 940 MB, with degraded resolution and frame rates. Conversely, the system of FIG. 2 or method of FIG. 3 performing the same video capture would produce a movie file (as the video data) having a size of approximately 175 MB. Further, for an hour of game play, the resulting movie file size would be approximately 300 MB. This non-linear relationship between the required storage size and the length of video capture is due, at least in part, to the reusability of the source data used in the computer game 102, as well as the relatively small size and high compressibility of the native command stream 206. Reusability of the source data (e.g., the native vertices 208 and the native textures 210) refers to aspects of the source data that can be stored once and referenced multiple times, without being duplicated for each frame, which contributes to the space savings.

As another example, in view of the performance benefits and space savings set forth above, video captures having longer durations (i.e., lengths of recording) can be performed. As a result, real-time syndicated video capture of game play from the computer game 102 could be performed among multiple players simultaneously. In this manner, a first player could be recording the game play from his or her computer game 102 and transmitting it to a second player (e.g., over the Internet), wherein the second player is playing another copy of the computer game 102 in conjunction with the first player. Thus, the real-time video capture of the game play of the first player can be displayed (e.g., overlaid in a picture-in-picture format) in the game play of the second player, such that the second player is able to make decisions while playing the computer game 102 based on the additional intelligence of the first player's perspective.

As yet another example, playback of the captured video can be manipulated by the user, unlike the static information represented by the frame-by-frame rasterized images formed from the raw data 104. Attributes such as the camera angle can be manipulated by the user during playback. Accordingly, although the captured video is from a vantage point of the user's in-game perspective, the playback could be viewed from a different perspective (e.g., behind and above the user's in-game perspective). Polygonal and texture picking for in-game viewing is also possible with this approach. Users can readily modify these in-game aspects.

As still another example, the captured video supports extensible analysis thereon. The analysis can be performed on the captured video in real-time or non-real-time. The analysis can be used, for example, to track hashes of the native vertices 208 to identify electronic positioning locations that are unique for a player in a specific computer game. As a result, a relative positioning system could be devised to determine the exact location of the player in the computer game 102, as well as the proximity of the player to other players in the same computer game at the same time or over time. This kind of analysis can be helpful if a player wants to illustrate to other players how to attain a particular level, accomplish a quest, find a particular item, etc. within the computer game 102.

As another example, a captured texture 210 contains a unique set of data. This data can be hashed into a unique identifier of that texture. Thus, a user could insert their own texture for display in the computer game 102, during playback of the captured data, or the like by passing their own texture and the texture to be replaced to the system (e.g., the system shown in FIG. 2 and/or FIG. 3). The system then hashes the texture to be replaced and passes the resulting unique identifier of that texture and the user's texture to the SDD 204 or 304. The SDD 204 or 304 dynamically inspects each texture being sent down through the system from the computer game 102 and hashes these textures to create unique identifiers for each and every texture. If the user supplied texture to be replaced identifier matches any of the texture identifiers for the textures from the computer game 102, the SDD 204 or 304 will simply specify that the graphics driver 112 should render the user supplied texture in place of the computer game's 102 texture, modify the source data to include the user supplied texture in place of the computer game's 102 texture (e.g., for subsequent placement in the media container 218), or the like.

As yet another example, the system/method captures source data that is a 100% true representation of the graphics data output of the computer game 102, as opposed to some lesser representation thereof like the raw data 104 with or without some frames being skipped. Thus, playback of the captured video data is based on all of the key elements of the graphics data output of the computer game 102, since the source data is recorded as opposed to the rasterized images formed from the raw data 104.

The above description of specific embodiments has been given by way of example. From the disclosure given, those skilled in the art will not only understand the general inventive concepts and attendant advantages, but will also find apparent various changes and modifications to the structures and methods disclosed. For example, although exemplary embodiments described herein refer to specific types of operating systems, one of ordinary skill in the art will appreciate that the general inventive concepts can be readily applied to other operating systems. As another example, although exemplary embodiments described herein refer to the DirectX graphics library, one of ordinary skill in the art will appreciate that the general inventive concepts can be applied to other graphics libraries or technologies, such as OpenGL, that provide real-time graphics data to a graphics card. It is sought, therefore, to cover all such changes and modifications as fall within the spirit and scope of the general inventive concepts, as defined in the claims, and equivalents thereof.

What is claimed is:

1. A system for capturing graphics data, the system comprising:
a computer including an operating system; and
a first application executing with the operating system on the computer,
wherein the first application is operable to capture graphics data generated by a second application executing with the operating system on the computer, and
wherein the graphics data is non-rasterized data.

2. The system of claim 1, further comprising a supplanting device driver to which a native graphics driver is rendered subordinate,
wherein the supplanting device driver is operable to monitor and modify a command stream of a graphics library being used by the second application to generate the graphics data.

3. The system of claim 2, wherein the supplanting device driver is located in a kernel layer of the operating system.

4. The system of claim 2, wherein the graphics library is one of DirectX and OpenGL.

5. The system of claim 1, wherein the graphics data is in a vector graphics format.

6. The system of claim 1, wherein the first application uses a codec to compress the graphics data.

7. The system of claim 1, wherein the first application stores the graphics data in a predetermined file format.

8. The system of claim 1, wherein the first application includes a user interface for allowing a user to manipulate the graphics data.

9. The system of claim 8, wherein the user interface allows a viewing angle of the graphics data to be altered.

10. The system of claim 1, wherein the first application analyzes the graphics data to determine a relative location of an object using the graphics data.

11. A method of capturing graphics data, the method comprising:
intercepting graphics data being generated by a program executing on a computer, and
compressing the graphics data,
wherein the graphics data is intercepted prior to any rasterization of the graphics data.

12. The method of claim 11, further comprising storing the graphics data, after compression, on a data storage device.

13. The method of claim 12, further comprising retrieving the graphics data from the data storage device, and
displaying the graphics data on a display device.

14. The method of claim 13, further comprising allowing a user to manipulate the graphics data being displayed on the display device.

15. The method of claim 14, wherein the user can change a viewing angle of the graphics data being displayed on the display device.

16. The method of claim 11, further comprising analyzing the graphics data to determine a location of an object within the graphics data.

17. An article of manufacture comprising a computer-readable medium tangibly embodying instructions readable by a computer for performing a method of capturing graphics data, the method comprising:
intercepting graphics data being generated by a program executing on a computer, and
compressing the graphics data,
wherein the graphics data is intercepted prior to any rasterization of the graphics data.

18. The article of claim 17, further comprising storing the graphics data, after compression, on a data storage device.

19. The article of claim 17, further comprising allowing a user to manipulate the graphics data.

20. The article of claim 17, further comprising analyzing the graphics data to determine a relative location of an object using the graphics data.
